(19) United States
(12) Patent Application Publication
(10) Pub. No.: US 2008/0277311 A1
(43) Pub. Date: Nov. 13, 2008

(54) Packaging Box for Medicaments

(75) Inventors: Wilson Wang, East of Beijing (CN); Hewei Li, Beijing (CN); Yanfeng Wang, Beijing (CN); Hongfei Wang, East of Beijing (CN)

Correspondence Address: FISH & RICHARDSON P.C., PO BOX 1022, MINNEAPOLIS, MN, 55440-1022, US

(73) Assignee: QUANTUM HI-TECH RESEARCH, Beijing (CN)

(21) Appl. No.: 11/815,520

(22) PCT Filed: Feb. 5, 2005
(86) PCT No.: PCT/CN2005/000166

§ 371 Date: Jun. 23, 2008

(51) Int. Cl. A61J 1/03

(52) U.S. Cl. 206/570

(57) ABSTRACT

A packaging box for medicaments, which can comprise: a bottom panel (1); a first-top panel (4); a second-top panel (5); a first-side panel (3a), being between said bottom panel (1) and first-top panel (4) and connected to them; a second-side panel (3b), being between said bottom panel (1) and second-top panel (5) and connected to them; a third-top panel (6), being connected to the second-top panel (5) and being opposing to said second-side panel (3b); some blisters (8) for the storage of medicaments, being provide don the third-top panel (6) and protruding therefrom; and supporting means (2) being provided on the internal surface of said bottom panel (1) so as to support said third-top panel (6).

### FIELD OF THE INVENTION

The present invention relates to a packaging box for medicaments, and more particularly to a wallet-like packaging box for medicaments.

### DESCRIPTION OF THE RELATED ART

A conventional packaging box for medicaments is a box which is formed by attaching two overlapped adjacent sides by means of an adhesive so as to constitute a chamber. And then the medicaments, a package insert or the like are put into the chamber and sealed by means of a tuck-in tab or the like. When a patient wants to take medicaments, he/she could open the packaging box and take out medicaments packed by a blister part, fetch the medicaments as required from the blisters, and then put the remaining medicaments back into the packaging box. In daily life, and especially in case the medicaments need to be taken immediately, the patient often forgets to put the remaining medicaments back into the packaging box due to hurry, so that the medicaments contained in the blisters are kept being exposed under an outer circumstance for a long time. And as a result, the medicaments may lose their effect due to being damaged or polluted. Moreover, since the medicaments have not been put back into the packaging box in time, the packaging box may be lost or thrown away, and therefore the package insert may be lost. And if the patient takes the medicaments next time, he/she can not take the medicaments properly due to the lack of directions recorded on the packaging insert, so that the patient may be hurt somewhat. In addition, some kinds of prepared drugs, such as directly compressed tablets, freeze-dried tablets or the like, are fragile during transportation, and therefore it is very difficult to transport these types of medicaments.

Therefore, the inventor of the present invention carries out deep research to solve the problems as mentioned above, and proposes the present invention.

### SUMMARY OF THE INVENTION

An object of the present invention is to provide a packaging box which is easy to be packed and can save carton sheets, and in which the medicaments, box body and package insert can be formed as one piece. And the medicaments will be prevented from being impacted and pressed when the medicaments are contained in the packaging box. It is particularly useful for the prepared drugs which are fragile.

To achieve above object, the present invention provides a packaging box for medicaments, comprising: a bottom panel; a first-top panel; a third-top panel; a first-side panel, said first-side panel being connected between the bottom panel and the first-top panel; a second-side panel, said second-side panel being connected between the bottom panel and the third-top panel; one or more blisters in which the medicaments are contained, said blister being provided on the third-top panel; and supporting means, said supporting means being provided on an internal surface of the bottom panel so as to support the third-top panel.

The blisters on the third-top panel protrude upwards in an open state. While the medicaments are being packed, the protruding direction of the blisters varies with the folding of the third-top panel towards the bottom panel, and the supporting means on the bottom panel comes into contact with a part of the third-top panel between the blisters so as to support the top panel and the bottom panel in between, so that the medicaments contained in the blisters can be prevented form being damaged due to the top panel and the bottom panel being impacted or pressed during transportation.

Preferably, connection means is provided on the top panel of the packaging box for medicaments according to the present invention, for connecting the first-top panel to the third-top panel and/or the second-side panel after the packaging box has been assembled, so as to prevent the first-top panel from being open accidentally.

Preferably, the height of said supporting means is equal to or larger than the height of the blister.

In the packaging box for medicaments according to the present invention, there is no specific limitation to the number of the supporting means, so long as the supporting means can support the third-top panel and the bottom panel so that the blisters between the two panels can be prevented from impact and press during transportation. Preferably, the packaging box comprises a plurality of supporting means.

There is no specific limitation to the shape of the supporting means. The supporting means is preferably a supporting bar. Said supporting bar has a cross section in a shape selected from a group consisted of triangular, square, rectangular, elliptical, semicircular shapes or a combination thereof.

There is no specific limitation to the arranging direction of the supporting means. The supporting means may be arranged in a longitudinal direction and/or a transverse direction, or may be arranged aslant. Preferably, the arranging direction of the supporting means is the same as that of the blisters.

There is no specific limitation to the connection means connecting the first-top panel and the third-top panel. It may comprise a tuck-in tab and a cut-out for cooperating with the tuck-in tab, or may comprise adhesive means. More preferably, it is adhesive means with an anti-counterfeiting mark.

The blisters in the present invention can be of any type of blisters in prior art, for example a type of blisters selected from a group including a plastic push-through blister, a push-through blister having double Al foils and an easy peeled blister. Preferably, the blisters are of easy peeled type.

According to another aspect of the present invention, there is provided a packaging box for medicaments comprising: a bottom panel; a first-top panel; a second-top panel; a first-side panel, said first-side panel being connected between the bottom panel and the first-top panel; a second-side panel, said second-side panel being connected between the bottom panel and the second-top panel; a third-top panel connected to the second-top panel and being opposite to the second-side panel; one or more blisters in which the medicaments are contained, said blister being provided on the third-top panel; and supporting means, said supporting means being provided on an internal surface of the bottom panel so as to support the third-top panel.

Preferably, connection means is provided on the first-top panel of the packaging box for medicaments according to the present invention, in order to prevent the first-top panel from being opened accidentally after the packaging box has been assembled.

Preferably, the height of said supporting means is equal to or larger than the height of the blister. Said supporting means is a supporting bar, said supporting bar has a cross section in a shape selected from a group including triangular, square, rectangular, elliptical, semicircular shapes or a combination thereof.

### BRIEF DESCRIPTION OF THE DRAWINGS

FIG. 1 is a perspective view of a packaging box for medicaments according to a first embodiment of the present invention when it is in an open state;

FIG. 2 is a perspective view of a packaging box for medicaments according to a second embodiment of the present invention when it is in an open state;

FIG. 3 is a perspective view of a packaging box for medicaments according to a third embodiment of the present invention when it is in an open state;

FIG. 4 is a perspective view of a packaging box for medicaments according to a fourth embodiment of the present invention when it is in an open state;

FIG. 5 is a perspective view of a packaging box for medicaments according to a fifth embodiment of the present invention when it is in an open state; and

FIG. 6 is a side view of the packaging box shown in FIG. 2 in case it is in an assembled state after the medicaments have been packed.

### DETAILED DESCRIPTION OF THE PREFERRED EMBODIMENTS

A packaging box for medicaments according to the present invention will be explained in more detail with reference to the accompanying drawings and in connection with preferred embodiments, where like element is indicated by same reference numbers throughout the drawings.

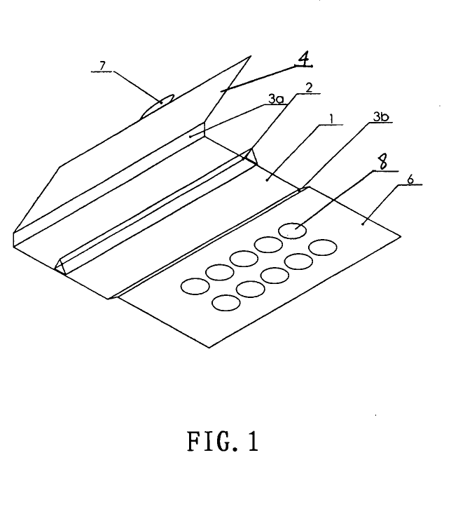

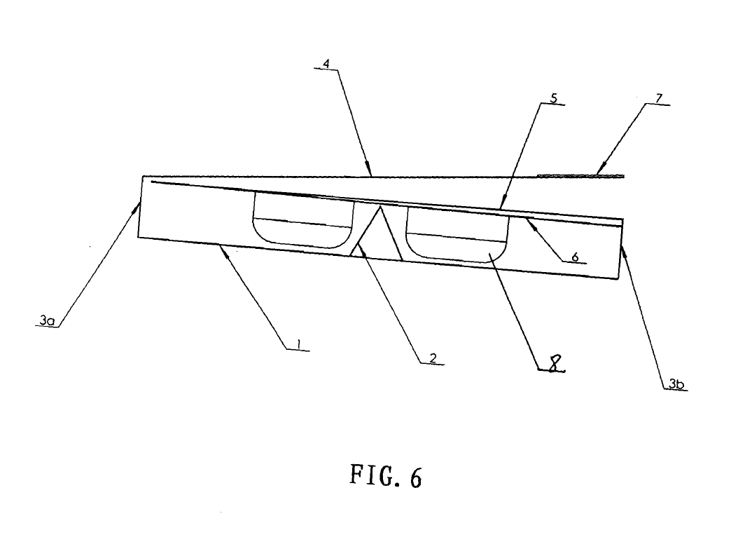

Hereinafter, a packaging box for medicaments according to a first embodiment of the present invention will be explained with reference to FIG. 1. As shown in FIG. 1, the packaging box for medicaments according to the first embodiment of the present invention comprises: a bottom panel 1 having a first side and an opposite second side; a first-side panel 3a having a first side and an opposite second side, said first side of the first-side panel 3a being connected to the second side of the bottom panel 1; a second-side panel 3b having a first side and an opposite second side, the width of the second-side panel 3b being substantially equal to the width of the first-side panel 3a, the second side of said second-side panel 3b being connecting to the first side of the bottom panel 1; a first-top panel 4 having a first side and an opposite second side, the first side of said first-top panel 4 being connected to the second side of said first-side panel 3a; a third-top panel 6 having a first side and an opposite second side, the second of the third-top panel 6 being connected to the first side of the second-side panel 3b, and the width of the third-top panel 6 being substantially equal to the width of the first-top panel 4, so that the first-top panel 4 can cover the third-top panel 6 after the packaging box has been assembled; a plurality of blisters 8 (see FIG. 6) for containing medicaments (not shown), said blisters being provided on the third-top panel 6, and the blisters protruding upwards from the third-top panel 6 in the state of the packaging box being opened, so that the blisters protrude down towards the bottom panel 1 after the packaging box has been assembled, and an end of each of the blisters which is connected to the third-top panel 6 being opened, the other end of each blister being closed, so that medicaments could be contained therein (of course, the open ends of the blisters could be closed properly after the medicaments have been put into the blisters. For example, it is possible to cover the corresponding surface of the third-top panel 6 with a thin film (not shown) so as to close the open end of the blisters 8); supporting means 2, said supporting means 2 being provided on a inner surface of the bottom panel 1 (i.e., a surface facing the inner space of the packaging box when the packaging box is in a state of being assembled) and having a height substantially equal to or somewhat larger than the height of the blisters 8 protruding up from the third-top panel 6; connection means 7 for connecting the first-top panel 4 and the third-top panel 6 together. It should be noted that the bottom panel 1, the first-top panel 4, the first-side panel 3a, the second-side panel 3b and the third-top panel 6 could be formed individually, and then connected together as described above. Preferably, the bottom panel 1, the first-top panel 4, the first-side panel 3a, the second-side panel 3b and the third-top panel 6 could be formed integrally by using one piece of carton sheet, where the adjacent panels are distinguished by creases formed between them and connected by these creases. Further, the supporting means 2 is not limited only to be provided on the bottom panel 1, and may be provided on the third-top panel 6 and on the same side as the blisters. Preferably, the package box for medicaments further comprises connection means 7, said connection means 7 is used to prevent the first-top panel 4 from being opened accidentally after the packaging box has been assembled, and thereby prevent the packaging box from being opened accidentally. Said connection means 7 may be adhesive means, or may comprise a tuck-in tab and a cut-out for cooperating with the tuck-in tab, the tuck-in tab could be provided on the first-top panel 4, and the cut-out could be provided on the third-top panel 6, on the second-side panel 3b or at a connection between the third-top panel and the second-side panel 3b. Further, there is no particular limit to the location of the adhesive means, for example, it could be provided on the first-top panel 4 (FIG. 1), on the second-side panel 3b or on the external surface of the bottom panel 1.

A flow of assembling the packaging box for medicaments according to the first embodiment of present invention will be described below. First of all, the medicaments are put into the blisters 8, and the third-top panel 6 on which the blisters 8 are provided is folded towards the bottom panel 1 along the crease between them. Since the third-top panel 6 is folded towards the bottom panel 1, the blisters 8 will be in a state of protruding down towards the bottom panel 1. And then, the first-top panel 4 is folded towards the bottom panel 1 along a crease, thus the first-top panel 4 and the third-top panel 6 will overlap each other. Next, the first-top panel 4, the third-top panel 6 and/or the second-side panel 3b are connected together by the connection means 7, so that a box having an internal space is formed to package the medicaments in the blisters. The supporting means 2 is located inside the inner space of the box at a position between the overlapped first-top panel 4 and the third-top panel 6 and the bottom panel 1, where the first-top panel 4 and the third-top panel 6 are superposed over the bottom panel 1, and the supporting means functions to support these panels, thereby preventing the blisters from being crushed so as to damage the medicaments therein when the first-top panel 4 and the third-top panel 6 and bottom panel 1 are pressed towards each other during transportation. It should be noted that the supporting means 2 is located not to interfere with the blisters 8 after the packaging box has been assembled, as shown in FIG. 6.

When a person wants to take the medicaments, he/she could unpack the packaging box in a reverse order with respect to the assembling order as described above. The connection means 7 is disconnected firstly, and then the third-top panel 6 and the first-top panel 4 are unpacked respectively along the creases, thus the blisters containing the medicaments are exposed. The medicaments could be taken out of the blisters in a way depending on the nature of the blisters.

As described above, the construction, assembling and unpacking of the packaging box according to the present invention are all similar to a wallet, and accordingly, the packaging box for medicaments according to the present invention could be referred to as a “wallet-like” packaging box for medicaments.

In the embodiment as shown in FIG. 1, the supporting means 2 is a supporting bar with a triangular cross section, and arranged in a longitudinal direction of the bottom panel 1. However, the supporting means is not limited to bar-like supporting means with a triangular cross section as shown in FIG. 1. It could have a cross section in circular, semicircular, square, rectangular, or elliptical shape or any combination thereof or the like, but the supporting means with a triangular cross section is preferred.

There is no specific limitation to the number of the supporting means 2. It is possible to arrange a number of supporting means as required, such as two or three supporting means. The blisters 8 provided on the third-top panel 6 could be any type of blisters in prior art, such as a blister selected from the group including a plastic pushed-through blister, a pushed-through blister having double Al foils and an easy peeled blister. Preferably, the blisters are of easily peeled type.

There is no limitation to the number of the blisters 8, and it is possible to adjust the proper number of the blisters depending on the characteristic of the medicaments and the demand of the market. As a preferred embodiment of the present invention, FIG. 1 illustrates that the number of the blisters is 10, where these 10 blisters 8 are divided into two rows and each row has 5 blisters.

There is no specific limitation to the connection means 7 for connecting the first-top panel 4 and the third-top panel 6, as long as it can connect the first-top panel 4 and the third-top panel 6 together. Said connection means comprises a tuck-in tab and a cut-out cooperating with one another and provided on the first-top panel 4 and the side panel 3b respectively, or comprises adhesive means provided on the first-top panel 4. The adhesive means is the preferred connection means.

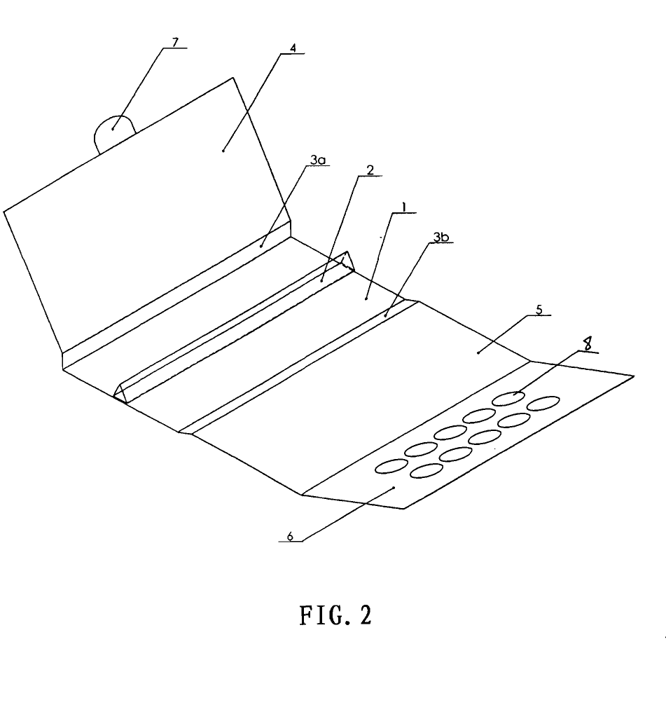

A second embodiment of the present invention will be described below with reference to FIG. 2. As shown in FIG. 2, the packaging box for medicaments according to the second embodiment of the present invention is similar to the first embodiment shown in FIG. 1, except that a second-top panel 5 is connected between the second-side panel 3b and the third-top panel 6, and the blisters 8 provided on the third-top panel 6 protrude downwards. As described above, the second-top panel 5 connected between the second-side panel 3b and the third-top panel 6, the first-top panel 4, the first-side panel 3a and bottom panel 1 may be formed integrally by one piece of carton sheet, where the adjacent panels are distinguished by creases formed there between and connected by these creases.

According to the “wallet-like” packaging box for medicaments of the present invention, thanks to the supporting means supported between the bottom panel and the third-top panel when the medicaments have been contained in the blisters and the packaging box has been assembled. Therefore, the blisters could be prevented from being deformed due to impact or press, so that the medicaments in the blisters can be prevented from being impacted or pressed so as to be crushed.

A flow of assembling the packaging box for medicaments according to the second embodiment of the present invention will be explained below with reference to FIG. 2 and FIG. 6. When the packaging box shown in FIG. 2 is assembled, first of all, the third-top panel 6 is folded towards the second-top panel 5 along a crease so as to be superposed on the second-top 5. Then, the third-top panel and the second-top panel 5 are folded towards the bottom panel 1 along a crease between the second-side panel 3b and the second-top panel 5, so that the blisters 8 provided on the third-top panel 6 will protrude down towards the bottom panel 1 after the third-top panel 6 has been folded twice. Hereafter, the first-top panel 4 is folded towards the bottom panel 1 along a crease, and then the first-top panel 4 will be superposed on the second-top panel 5 and the third-top panel 6. Next, the first-top panel 4 will be connected to the second-top panel 5 by the connection means 7. The first-side panel 3a, the second-side panel 3b and the supporting means 2 on the bottom panel 1 are used to support the first-, the second- and the third-top panels 4,5,6, so that the three top panel overlapped with each other could be spaced apart from one another by a certain distance. The distance is larger than or equal to the height of the blisters, thus the blisters containing the medicaments can be prevented form coming into contact with the bottom panel 1, so that the medicaments contained in the blisters can be prevented from being crushed due to impact or press.

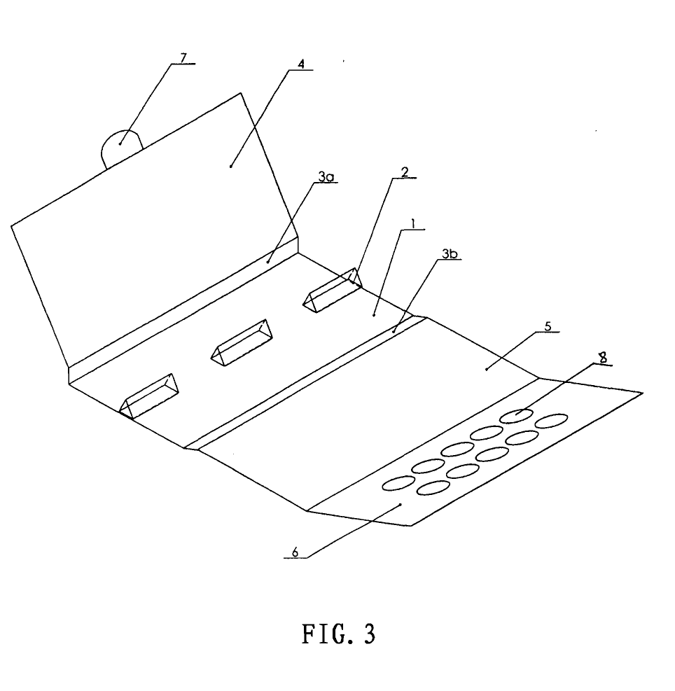

FIG. 3 is a perspective view showing a packaging box for medicaments according to a third embodiment of the present invention. As shown in FIG. 3, the packaging box is similar to the second embodiment, except the supporting means 2. In the third embodiment shown in FIG. 3, the supporting means 2 comprises three spaced supporting bars which are arranged to be aligned with one another in the longitudinal direction and each of which has a triangular cross section.

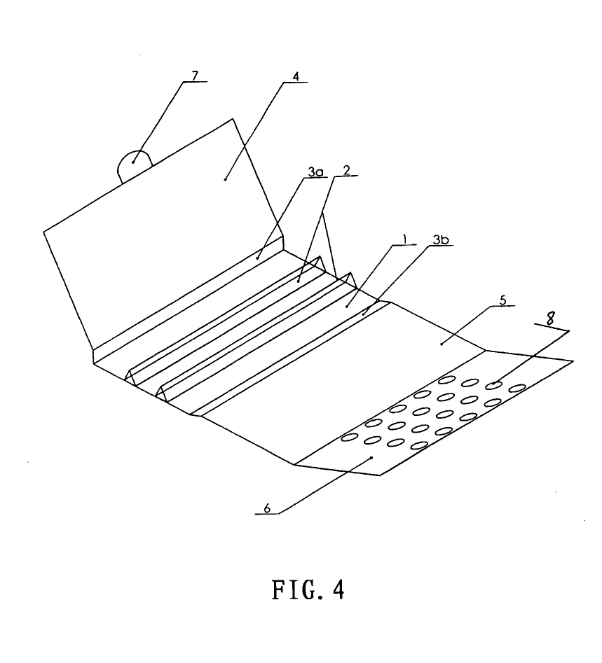

FIG. 4 is a perspective view showing a packaging box for medicaments according to a fourth embodiment of the present invention. As shown in FIG. 4, the packaging box is similar to the second embodiment shown in FIG. 2 and the third embodiment shown in FIG. 3, except the numbers of the supporting means 2 and the blisters 8. In the fourth embodiment shown in FIG. 4, the supporting means 2 comprises two supporting bars which are arranged parallel to each other in a longitudinal direction of the bottom panel 1 and each of which has a triangular cross section. The number of the blisters is 20, where the 20 blisters are grouped into 4 rows, each row including 5 blisters. Obviously, there is no specific limitation to the number of blisters and the number of rows. The numbers could be adjusted as required depending on the market demand and the packaging requirements. It can be seen in FIG. 4 that the number of blisters and the number of the rows are only illustrative. The practical numbers are not limit to them.

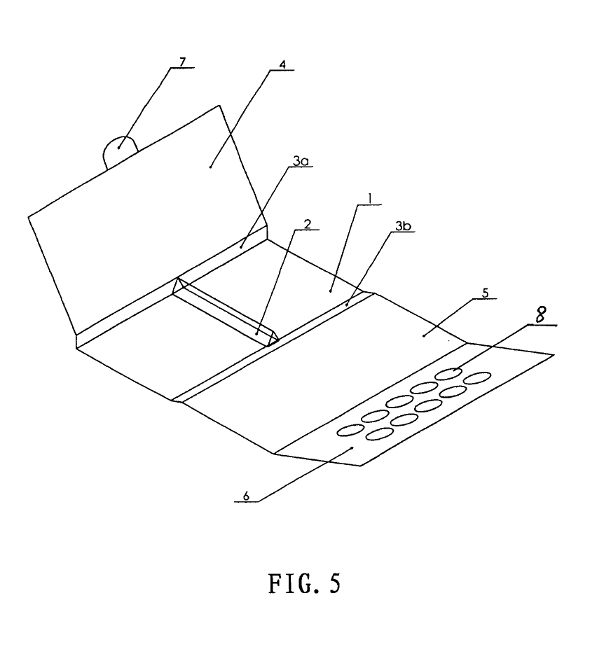

FIG. 5 is a perspective view showing a packaging box for medicaments according to a fifth embodiment of the present invention. As shown in FIG. 5, the packaging box is similar to the second embodiment shown in FIG. 2 and the third embodiment shown in FIG. 3, except the supporting means 2. In the fifth embodiment shown in FIG. 5, the supporting means 2 comprises one supporting bar which is arranged in a transverse direction of the bottom panel 1, i.e. in a direction that is perpendicular to the direction in which the supporting means is disposed according to the first to the fourth embodiments. Of course, in the fifth embodiment, there is no specific limitation to the number of bars of supporting means 2. For example, it could comprise two or three or more supporting bars.

FIG. 6 is a view showing an assembled state of the packaging box for medicaments according to the present invention, that is, a side view showing the packaging box according to the first embodiment shown in FIG. 2 after the medicaments have been packed therein. As shown in FIG. 6, the height of supporting means 2 for supporting the first-top panel 4 and the third-top panel 6 or for supporting the first-top panel 4, the third-top panel 6 and the second-top panel 5 (corresponding to the second to the fifth embodiments, respectively) is substantially equal to or somewhat larger than the height of the blisters, and the supporting means 2 is located not to interfere with the blisters after the packaging box has been assembled.

As seen in FIG. 6, after the medicaments have been received in the packaging box, the supporting box 2 can support the first-top panel 4, the second-top panel 5 and the third-top panel 6, so that the medicaments contained in the blisters can be prevented from being crushed due to the deformation when the top panels and bottom panel are pressed together for example during transportation.

Although the present invention is described in detail with reference to the accompanying drawings, it is only for the purpose of illustration. It will be apparent to those skilled in the art that various modifications and variations can be made in the embodiments of the present invention without departing from the spirits or scopes of the invention. Thus, it is intended that the present invention covers the modifications and variations of this invention provided that they fall in the scope of the appended claims and their equivalents.

1. A packaging box for medicaments, comprising:
a bottom panel;
a first-top panel;
a third-top panel;
a first-side panel (3a), said first-side panel being connected between the bottom panel and the first-top panel;
a second-side panel, said second-side panel being connected between the bottom panel and the third-top panel;
one or more blisters in which the medicaments are contained, said blisters being provided on the third-top panel; and
supporting means, said supporting means being provided on an internal surface of the bottom panel so as to support the third-top panel.

2. The packaging box for medicaments according to claim 1, wherein the height of said supporting means is equal to or larger than the height of the blister.

3. The packaging box for medicaments according to claim 1, wherein said packaging box comprises a plurality of said supporting means.

4. The packaging box for medicaments according to claim 1, wherein said supporting means is a supporting bar, said supporting bar having a cross section in a shape selected from the group consisting of triangular, square, rectangular, elliptical, and semicircular shapes, or a combination thereof.

5. The packaging box for medicaments according to claim 4, wherein the supporting means is arranged in a longitudinal direction and/or a transverse direction of the bottom panel.

6. The packaging box for medicaments according to claim 1, further comprising a connection means provided on the first-top panel, said connection means being used to prevent the first-top panel from being opened accidentally after the packaging box for medicaments has been assembled.

7. The packaging box for medicaments according to claim 6, wherein said connection means comprises adhesive means.

8. The packaging box for medicaments according to claim 1, further comprising a connection means for preventing the first-top panel from being opened accidentally after the packaging box for medicaments has been assembled, wherein said connection means comprises a tuck-in tab and a cut-out for cooperating with the tuck-in tab, and wherein one of the tuck-in tab and the cut-out is disposed on the first-top panel, and the other one of the tuck-in tab and the cut-out is disposed on the third-top panel, or on the second-side panel, or at a connection between the third-top panel and the second-side panel.

9. A packaging box for medicaments, comprising:
a bottom panel;
a first-top panel;
a second-top panel;
a first-side panel, said first-side panel being connected between the bottom panel and the first-top panel;
a second-side panel, said second-side panel being connected between the bottom panel and the second-top panel;
a third-top panel connected to the second-top panel and being opposite to the second-side panel;
one or more blisters in which the medicaments are contained, said blister being provided on the third-top panel; and
supporting means, said supporting means being provided on an internal surface of the bottom panel so as to support the third-top panel.

10. The packaging box for medicaments according to claim 9, wherein the height of said supporting means is equal to or larger than the height of the blister.

11. The packaging box or medicaments according to claim 9, wherein it comprises a plurality of supporting means.

12. The packaging box for medicaments according to claim 9, wherein said supporting (2) is a supporting bar, said supporting bar having a cross section in a shape selected from the group consisting of triangular, square, rectangular, elliptical, and semicircular shapes, or a combination thereof.

13. The packaging box for medicaments according to claim 12, wherein the supporting means is arranged in a longitudinal direction and/or a transverse direction of the bottom panel.

14. The packaging box for medicaments according to claim 9, further comprising a connection means provided on the first-top panel, said connection means being used to prevent the first-top panel from being opened accidentally after the packaging box for medicaments has been assembled.

15. The packaging box for medicaments according to claim 14, wherein said connection means comprises adhesive means.

16. The packaging box for medicaments according to any one of claims 9-11, further comprising a connection means for preventing the first-top panel from being opened accidentally after the packaging box for medicaments has been assembled, wherein said connection means comprises a tuck-in tab and a cut-out for cooperating with the tuck-in tab, wherein one of the tuck-in tab and the cut-out is disposed on the first-top panel, and the other one of the tuck-in tab and the cut-out is disposed or the third-top panel, or on the second-side panel, or at a connection between the third-top panel and the second-side panel.
